(19) United States
(12) Patent Application Publication
(10) Pub. No.: US 2012/0120844 A1
(43) Pub. Date: May 17, 2012

(54) METHOD, SYSTEM AND BASE STATION FOR ENHANCED COMMUNICATION EFFICIENCY

(75) Inventors: Christian Prechtl, Wien (AT); Wolfgang Wirths, Bonn (DE); Patrick Froeller, Wiener Neustadt (AT)

(73) Assignee: T-MOBILE AUSTRIA GMBH, Wien (AT)

(21) Appl. No.: 13/386,066

(22) PCT Filed: Jul. 19, 2010
(86) PCT No.: PCT/EP2010/004391

§ 371 Date: Jan. 20, 2012

Related U.S. Application Data
(60) Provisional application No. 61/227,256, filed on Jul. 21, 2009.

(30) Foreign Application Priority Data
Jul. 21, 2009 (EP) 09009454.1

(51) Int. Cl. H04W 24/00; H04L 12/26

(52) U.S. Cl. 370/253

(57) ABSTRACT

A method is provided for enhanced communication efficiency within a mobile radio network cell of a cellular mobile radio network. The method includes: providing a base transceiver station and a plurality of mobile stations in the mobile radio network cell; transmitting a control message, from the base transceiver station to the plurality of mobile stations, the control message comprising modification information indicating that modified transmission conditions are to be applied during a predetermined time interval; and applying the modified transmission conditions to a transmission request received at the base transceiver station from a mobile station within the predetermined time interval, wherein the transmission request is a request to transmit non-real-time related traffic data to the mobile station.

### CROSS-REFERENCE TO RELATED APPLICATIONS

This patent application is a national stage entry under 35 U.S.C. §371 of International Application No. PCT/EP2010/004391, filed Jul. 19, 2010, and claims priority to European Patent Application No. EP09009454.1, filed Jul. 21, 2009, and U.S. Provisional Patent Application No. 61/227,256, filed Jul. 21, 2009. The International Application was published in English on Jan. 27, 2011, as WO 2011/009578 A1.

### FIELD

The present invention relates to a method, a system and a base station that allows a more efficient communication within a cell of a cellular mobile radio network by optimizing the traffic load in a communication network.

### BACKGROUND

The traffic capacity of conventional mobile radio networks has a utilization level which fluctuates greatly as a function of time, e.g., in the course of a day. At low traffic times, sometimes more than 90% of the existing capacity is not used. In order to assure an optimal quality of service within the mobile radio network, it is necessary to dimension the capacity of the mobile radio network according to peak demand times, which means that for long periods of time no efficient use is made of the network equipment of the mobile radio network.

European Patent EP 1 326 453 B1 describes an arrangement for optimizing the traffic load in a telecommunication and/or data network having a network operation control unit, a plurality of network elements which are functionally independent, and a plurality of content databases, wherein by means of an evaluation and decision unit load messages are evaluated and control signals are output to selected content databases for transmitting predetermined contents or other information to users' telecommunication or data terminals connected to the communication network.

The drawback of such an approach is that network components such as the evaluation and decision unit needs knowledge of the communication needs of the terminals. This means that such communication needs are to be transmitted to such a network component prior to optimizing the network load, and stored in the network component or an assigned storage device. This increases the overhead for optimizing the network utilization level and necessitates the provision and maintenance of complex user interface solutions as well as storage capabilities as well as the need to assure data integrity and data security of such user specific data regarding communication requirements.

### SUMMARY

In an embodiment, the present invention provides a method for enhanced communication efficiency within a mobile radio network cell of a cellular mobile radio network. The method includes providing a base transceiver station and a plurality of mobile stations in the mobile radio network cell; transmitting a control message, from the base transceiver station to the plurality of mobile stations, the control message comprising modification information indicating that modified transmission conditions are to be applied during a predetermined time interval; and applying the modified transmission conditions to a transmission request received at the base transceiver station from a mobile station within the predetermined time interval. The transmission request is a request for the base transceiver station to transmit non-real-time related traffic data to the mobile station. The modification information includes of information about quantity of traffic data to be transmitted from the base transceiver station to the plurality of mobile stations under the modified transmission conditions, information about at least one of the beginning and the end of the predetermined time interval, and information about quantity of non-real-time related traffic data to be transmitted from the base transceiver station to the plurality of mobile stations under the modified transmission conditions.

### BRIEF DESCRIPTION OF THE DRAWINGS

FIG. 1 shows schematically an example of a typical network utilization curve as a function of time.

FIG. 2 shows schematically a cell of a mobile radio network.

FIGS. 3 and 4 show schematically an exchange of information between the base station and a mobile station according to the present invention.

### DETAILED DESCRIPTION

The present invention provides a method, a system and a base station for enhanced communication efficiency that allows for an easy and flexible use of non used network transmission capacities in a cell of a cellular mobile radio network.

In an embodiment, the method includes: providing a base transceiver station and a plurality of mobile stations in the mobile radio network cell, transmitting a control message from the base transceiver station to the mobile stations, the control message comprising a modification information indicating that modified transmission conditions are applied during a preferred time interval, wherein for a transmission request of one of the mobile stations to the base transceiver station within the preferred time interval by which the base transceiver station is requested to transmit non-real-time related traffic data to the one of the mobile stations, the modified transmission conditions are applied.

In an embodiment, the capacity of the mobile radio network is more efficiently used in a simple and flexible way for non-real-time related data.

In the context of the present invention, non-real-time related traffic data are data such as, e.g., text or e-mail messages, video data relating to a video content or the like that are not involved in a communication situation requiring immediate reaction. Communication situations involving immediate reaction comprise for example voice call communications or video call communications, whereas non-real-time related traffic data relate to, e.g., e-mail messages, Video on Demand (VoD) content (to be watched at a later time), or the like. For example, the base station (or another network entity) can define the time of transmission within a predefined time interval after the transmission request (of the mobile station), the predefined time interval being, e.g., a certain number of minutes (such as 5 or 10 or 15 or 20 or 25 or 30 or 35 or 40 or 45 or 50 or 55 minutes), or a certain number of hours (such as one hour or two hours or three hours), or a combination thereof.

The control message can be a standardized control message indicating that a preferred data transmission within the cell of the mobile radio network is possible and modified transmission conditions are to be applied.

In an embodiment, the control message is a CB (Cell Broadcast) message, especially a SMSCB message (Short Message Service Cell Broadcast). The SMSCB is a service in which short messages may be broadcast from a base station or BTS (Base Transceiver Station) of a PLMN (Public Land Mobile Network) to mobile stations or terminals. SMSCB messages can have different sources, e.g., traffic reports, weather reports or the like. The source and subject of the SMSCB message is identified by a message identifier in the SMSCB message header. A sequence number in the SMSCB message header enables the mobile station to determine when a new message from a given source is available.

In a further embodiment, the preferred time interval is a predetermined time interval, and the modification information transmits, explicitly or implicitly, information about the beginning and the end of the preferred time interval.

In a further embodiment, the modification information transmits, explicitly or implicitly, information about the quantity of traffic data to be transmitted from the base transceiver station to the mobile stations under the modified transmission conditions.

In both embodiments mentioned above, the beginning and the end of the allotted privileged communication conditions are advantageously defined by means of one single cell broadcast message defining either the time period or the quantity of data to be exchanged according to the preferred conditions. In the event that a user or a terminal (mobile station) needs to transmit (e.g. download) a comparably large quantity of data, it is possible to evaluate whether such a data transmission is possible within the allotted time or quantity of traffic data.

According to another embodiment, the preferred time interval is a predetermined time interval, wherein the modification information transmits explicitly or implicitly an information about the beginning and the end of the preferred time interval, and wherein the modification information transmits explicitly or implicitly an information about the quantity of traffic data to be transmitted from the base transceiver station to the mobile stations under the modified transmission conditions.

The preferred time interval is predefined and the quantity of traffic data to be transmitted under the modified transmission conditions is predefined. Thereby, it is possible that the mobile station is able to at least potentially determine whether a specific data transmission is possible to realize or not (e.g., in a situation of non-optimal data transmission rate due to interference problems at the location of the mobile station).

According to still another embodiment, the modification information transmits, explicitly or implicitly, information only about the beginning of the preferred time interval, and information about the end of the preferred time interval is transmitted by means of a further control message from the base transceiver station to the mobile stations within the cell of the cellular mobile radio network.

The end of the preferred time interval is signaled to the mobile station by means of a further control message.

In an embodiment, the modification information preferably indicates that, within the preferred time interval, a lower price for the transmission of the traffic data is to be applied.

Thereby, it is advantageously possible to more effectively use the mobile radio network capacity during such times where usually a low usage of the network is experienced.

Furthermore, in an embodiment, the control message comprises the modification information indicating that modified transmission conditions are applied during a preferred time interval is transmitted in dependency of the traffic load of the cell of the cellular mobile radio network or in dependency of the traffic load of the cell and of adjacent cells of the cellular mobile radio network.

Thereby, it is advantageously possible that the method according to the present invention can also be applied for the case where a mobile station changes the cell of the mobile radio network.

In an embodiment, the invention further provides a system for enhanced communication efficiency within a cell of a cellular mobile radio network, the system comprising a base transceiver station and a plurality of mobile stations in the mobile radio network cell, wherein a control message is transmitted from the base transceiver station to the mobile stations, the control message comprising a modification information indicating that modified transmission conditions are applied during a preferred time interval, wherein for a transmission request of one of the mobile stations to the base transceiver station within the preferred time interval by which the base transceiver station is requested to transmit traffic data to the one of the mobile stations, the modified transmission conditions are applied.

In an embodiment, the invention further provides a base transceiver station for a cell of a cellular mobile radio network, the cell comprising a plurality of mobile stations, wherein the base transceiver station transmits a control message to the mobile stations, the control message comprising modification information indicating that modified transmission conditions are applied during a preferred time interval, wherein for a transmission request of one of the mobile stations to the base transceiver station within the preferred time interval by which the base transceiver station is requested to transmit traffic data to the one of the mobile stations, the modified transmission conditions are applied.

In an embodiment, the invention further provides a program comprising a computer readable program code for controlling a base transceiver station for a cell of a cellular mobile radio network, the cell comprising a plurality of mobile stations, wherein the base transceiver station transmits a control message to the mobile stations, the control message comprising a modification information indicating that modified transmission conditions are applied during a preferred time interval, wherein for a transmission request of one of the mobile stations to the base transceiver station within the preferred time interval by which the base transceiver station is requested to transmit traffic data to the one of the mobile stations, the modified transmission conditions are applied.

In an embodiment, the invention further provides a computer program product comprising a computer readable program code according to the present invention. for controlling a base transceiver station.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

According to the present invention, an enhanced communication efficiency—especially a better use of periods of time during which the communication capacity of the network is by far not completely used by normal voice and/or data traffic—within a cell of a cellular mobile radio network is possible to achieve by means of transmitting a control message from a base transceiver station to the mobile stations of the cell.

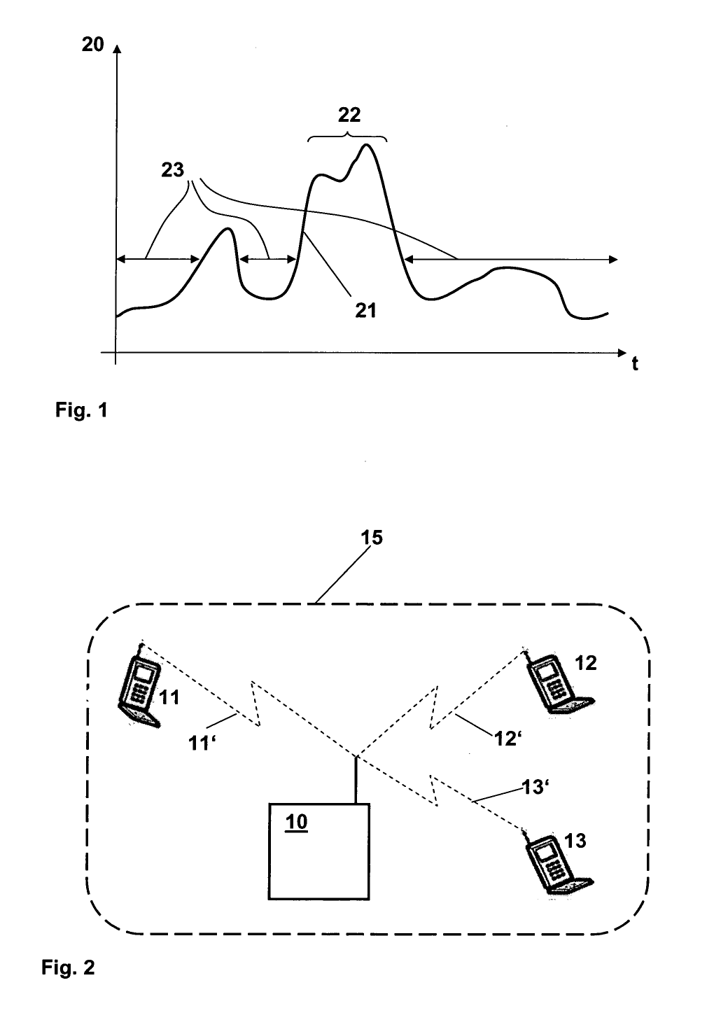

FIG. 1 schematically shows an example of a typical network utilization curve 21 as a function of time t (abscissa). The ordinate (y-axis) corresponds to the network transport or network transmission capacity 20. The network utilization curve 21 shown can be divided into segments where a comparably high usage level is realised—an example of such a high-traffic time is designated by reference sign 22—and into segments where a comparably low usage level is realised—examples of such low-traffic times are designated by reference sign 23.

FIG. 2 shows schematically a cell 15 of a cellular mobile radio network. In the exemplary configuration shown in FIG. 2, a base transceiver station 10 is connected to a plurality of mobile stations or mobile terminals. A first mobile station is designated by reference numeral 11. A second mobile station is designated by reference numeral 12. A third mobile station is designated by reference numeral 13. The base transceiver station 10 is connected to the first mobile station 11 by means of a first radio link 11′. The base transceiver station 10 is connected to the second mobile station 12 by means of a second radio link 12′. The base transceiver station 10 is connected to the third mobile station 13 by means of a third radio link 13′. It is evident, that the cell 15 can—dependent on the radio capacity of the mobile radio network and dependent on the capacity of the base transceiver station 10—also comprise more than three active mobile devices 11, 12, 13.

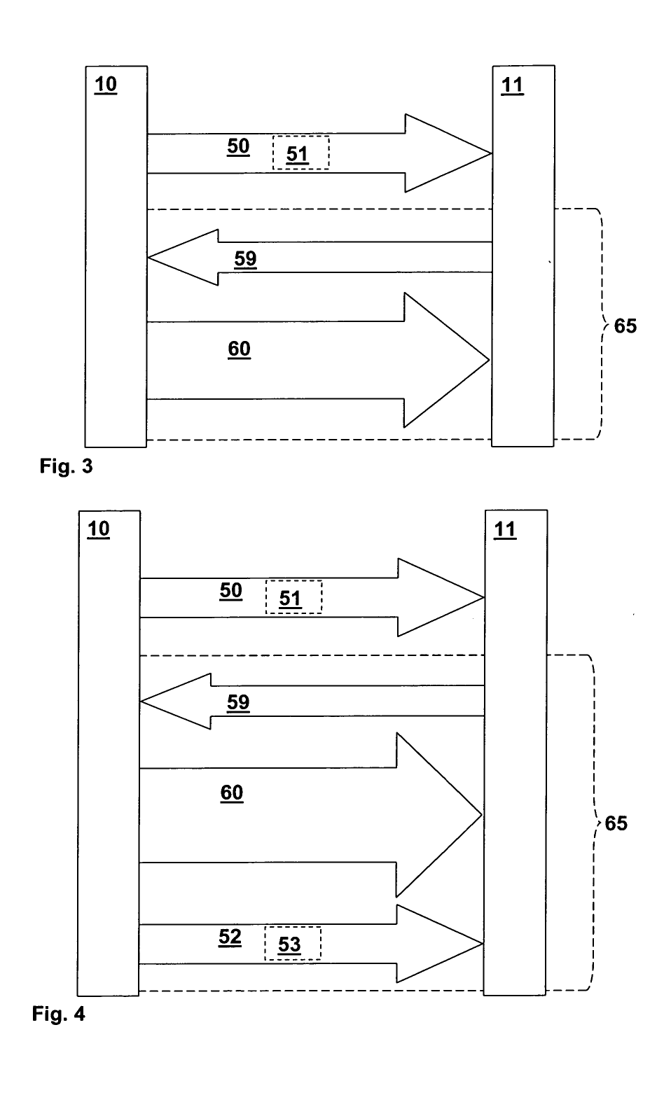

According to the present invention, the base transceiver station 10 can emit (via the radio links 11′, 12′, 13′) a control message 50 to the mobile stations 11, 12, 13. For the exemplary situation of the base transceiver station 10 being in contact with the first mobile station 11 (i.e. one of the mobile stations 11, 12, 13), FIGS. 3 and 4 show different possibilities of such an exchange of information between the base station and a mobile station according to the present invention. It is evident that instead of the first mobile station 11, also the second mobile station 12 or the third mobile station 13 could have been shown.

FIGS. 3 and 4 show the case where the base transceiver station 10 sends or transmits a control message 50. This control message is intended to inform all the mobile stations 11, 12, 13 within the cell 15 of the fact that modified transmission conditions can be applied during a so-called preferred time interval 65. The control message 50 is preferably a Cell Broadcast (CB) message. The control message 50 comprises modification information 51 indicating (to the mobile stations 11, 12, 13 receiving the control message 50) that the modified transmission conditions can be applied.

In the case shown in FIG. 3, the beginning and the end of the preferred time interval 65 is (implicitly or explicitly) predetermined by the control message 50. In this case, the first mobile station 11 sends a transmission request 59 to the base transceiver station 10 and traffic data 60 are sent from the base transceiver station 10 to the first mobile station 11. The request 59 to the base transceiver station 10 and the traffic data 60 concern non-real-time related traffic data 60, i.e. traffic data 60 that do not relate to a communication situation requiring immediate reaction. Communication situations involving immediate reaction comprise for example voice call communications or video call communications, whereas non-real-time related traffic data relate to, e.g., e-mail messages, Video on Demand (VoD) content to be watched.

Alternatively, a quantity of traffic data 60 can be defined by the control message 50 such that the first mobile station 11 is allowed to request this quantity of traffic data 60, e.g., 200 MB, under the modified transmission conditions.

Furthermore alternatively, both a quantity of traffic data 60 and a time interval 65 having a predefined beginning and a predefined end can be (explicitly or implicitly) transmitted by means of the control message 50.

In the case shown in FIG. 4, only the beginning of the preferred time interval 65 is (implicitly or explicitly) defined by the control message 50. In this case, the first mobile station 11 sends a transmission request 59 to the base transceiver station 10 and traffic data 60 are sent from the base transceiver station 10 to the first mobile station 10. As the end of the preferred time interval 65 is not predefined, a further control message 52 is sent from the base transceiver station 10 to the first mobile station 11. The further control message 52 comprises a normalization information 53 indicating that the preferred time interval 65 has ended or that the preferred time interval 65 will end at a predetermined time.

1-12. (canceled)

13. A method for enhanced communication efficiency within a mobile radio network cell of a cellular mobile radio network, the method comprising:
providing a base transceiver station and a plurality of mobile stations in the mobile radio network cell;
transmitting a control message, from the base transceiver station to the plurality of mobile stations, the control message comprising modification information indicating that modified transmission conditions are to be applied during a predetermined time interval; and
applying the modified transmission conditions to a transmission request received at the base transceiver station from a mobile station within the predetermined time interval,
wherein the transmission request is a request for the base transceiver station to transmit non-real-time related traffic data to the mobile station;
wherein the modification information includes information about quantity of traffic data to be transmitted from the base transceiver station to the plurality of mobile stations under the modified transmission conditions, information about at least one of the beginning and the end of the predetermined time interval, and information about quantity of non-real-time related traffic data to be transmitted from the base transceiver station to the plurality of mobile stations under the modified transmission conditions.

14. The method according to claim 13, wherein the control message is a CB (Cell Broadcast) message.

15. The method according to claim 13, wherein the modification information includes information about the beginning and not the end of the preferred time interval, and wherein normalization information about the end of the preferred time interval is transmitted by a further control message from the base transceiver station to the plurality of mobile stations within the mobile radio network cell.

16. The method according to claim 13, wherein the modification information indicates that, within the predetermined time interval, a lower price for transmission of traffic data is to be applied.

17. The method according to claim 13, wherein the control message is transmitted based on traffic load of the mobile radio network cell or based on traffic load of the mobile radio network cell and adjacent cells of the cellular mobile radio network.

18. A system for enhanced communication efficiency within a mobile radio network cell of a cellular mobile radio network, the system comprising:
a plurality of mobile stations; and
a base transceiver station, configured to transmit a control message from the base transceiver station to the plurality of mobile stations, the control message comprising modification information indicating that modified transmission conditions are to be applied during a predetermined time interval, and to apply the modified transmission conditions to a transmission request received at the base transceiver station from a mobile station within the predetermined time interval, wherein the transmission request for the base transceiver station is a request to transmit non-real-time related traffic data to the mobile station;
wherein the modification information includes of information about quantity of traffic data to be transmitted from the base transceiver station to the plurality of mobile stations under the modified transmission conditions, information about at least one of the beginning and the end of the predetermined time interval, and information about quantity of non-real-time related traffic data to be transmitted from the base transceiver station to the plurality of mobile stations under the modified transmission conditions.

19. A tangible, non-transitory computer-readable medium within a mobile radio network cell of a cellular mobile radio network, wherein a base transceiver station and a plurality of mobile stations are provided in the mobile radio network cell; the computer-readable medium having computer-executable instructions stored thereon, the computer-executable instructions comprising:
instructions for transmitting a control message, from the base transceiver station to the plurality of mobile stations, the control message comprising modification information indicating that modified transmission conditions are to be applied during a predetermined time interval; and
instructions for applying the modified transmission conditions to a transmission request received at the base transceiver station from a mobile station within the predetermined time interval, wherein the transmission request is a request for the base transceiver station to transmit non-real-time related traffic data to the mobile station;
wherein the modification information includes information about quantity of traffic data to be transmitted from the base transceiver station to the plurality of mobile stations under the modified transmission conditions, information about at least one of the beginning and the end of the predetermined time interval, and information about quantity of non-real-time related traffic data to be transmitted from the base transceiver station to the plurality of mobile stations under the modified transmission conditions.
